(19) United States
(12) Patent Application Publication
(10) Pub. No.: US 2021/0192407 A1
(43) Pub. Date: Jun. 24, 2021

(54) COMPUTER SYSTEM AND METHOD OF VERIFYING SCHEDULING SYSTEM

(71) Applicant: Hitachi, Ltd., Tokyo (JP)

(72) Inventors: Satoru WATANABE, Tokyo (JP); Mizuki MIYANAGA, Tokyo (JP)

(21) Appl. No.: 17/001,134

(22) Filed: Aug. 24, 2020

(30) Foreign Application Priority Data
Dec. 18, 2019 (JP) 2019-228676

(51) Int. Cl. G06Q 10/06; G06N 7/00; G06K 9/62; G06N 20/00

(52) U.S. Cl. CPC G06Q 10/06311; G06N 7/005; G06N 20/00; G06K 9/6228; G06K 9/6256

(57) ABSTRACT

A scheduling system generates a schedule formed of the entries, which are ordered by using a model for calculating a probability of selecting one of the entries. A computer system, which verifies the scheduling system, comprises: a selection module selecting at least one of the entries based on the target data for verification; a feature amount calculation module generating feature amount data formed of each of the entries; a feature amount estimation module estimating a feature amount which is a feature amount not included in the feature amount data; a selection probability calculation module calculating a probability of selecting the at least one of the entries; and an effect estimation module executing selection processing of selecting a candidate entry to be included in the schedule based on the selection probability, and generating information indicating a search range of the scheduling system based on a result of the selection processing.

### CLAIM OF PRIORITY

The present application claims priority from Japanese patent application JP 2019-228676 filed on Dec. 18, 2019, the content of which is hereby incorporated by reference into this application.

### BACKGROUND OF THE INVENTION

This invention relates to a technology of generating a schedule, for example, a production plan for a product.

A system utilizing artificial intelligence (AI) has been used more widely in various fields, such as medicine and industry. Automation of manual tasks by using those systems is expected. The system utilizing AI is hereinafter also referred to as “AI system”.

An algorithm that implements AI, namely, a model, is generated by machine learning using learning data. It is possible to enable the AI to import business knowledge in various fields by using learning data.

However, it is difficult to import some business knowledge, such as legal regulations and compliance rules, from learning data. Further, when there is only a small amount of learning data, the AI may not sufficiently import business knowledge. A system cannot be put into practical use without consideration of business knowledge that cannot be directly imported into the AI. Thus, a logic is required to be developed separately and imported into an AI system for business knowledge that is difficult to import from learning data.

Development of the AI system includes four steps, namely, setting of a goal, understanding of a business and preparation of learning data, development, and improvement of an accuracy. A technology described in JP 2017-194730 A is known as a method of achieving improvement of the accuracy of a developed system.

In JP 2017-194730 A, it is described that “According to the decision making support system 101, the causal relationship model update module 103 has an update information generation function 202 of generating temporary update model data for updating a causal relationship model based on a causal relationship model and a result of analysis by a data analysis function 202, and a model update evaluation function 213 of evaluating effectiveness of update with the temporary update model data, and the causal relationship model management module 105 has a model registration/update function 231 of updating the causal relationship model with the temporary update model data when a result of evaluation by the model update evaluation function 213 is equal to or larger than a fixed value.

### SUMMARY OF THE INVENTION

Practicability of the AI system for generating a schedule depends on various factors such as the difficulty of a problem to be handled, an AI algorithm, and the quality and amount of learning data. Thus, effectiveness verification for determining the practicability of the AI system is performed before introduction of the AI system.

In a related-art verification of the effectiveness of the AI system, in order to verify the AI system, it is necessary to complete the development of all processes and actually operate them. Thus, there is a problem in that, when the AI system is not put into practical use as a result of effectiveness verification, the time and workload required for development of the AI system are consumed in vain.

This invention is to provide a method of verifying an effect of an AI system under development.

A representative example of the present invention disclosed in this specification is as follows: a computer system, which is configured to verify a scheduling system generating a schedule. The scheduling system is configured to generate, in a case of receiving input of target data including a plurality of entries each being data on a target to be scheduled and including a plurality of data items, the schedule formed of the plurality of entries, which are ordered by using a model for calculating an entry selection probability based on a feature amount calculated based on values of the plurality of data items included in the one of the plurality of entries. The computer system comprises: at least one computer including an arithmetic device, a storage device coupled to the arithmetic device, and an interface coupled to the arithmetic device; a first storage module configured to manage information on the model; a selection module configured to select at least one of the plurality of entries from the target data for verification; a feature amount calculation module configured to calculate a feature amount based on the values of the plurality of data items included in the at least one of the plurality of entries selected by the selection module, and to generate feature amount data formed of the calculated feature amount; a feature amount estimation module configured to estimate a feature amount to be handled by the model, which is a feature amount not included in the feature amount data; a selection probability calculation module configured to calculate an entry selection probability by using the information on the model, the feature amount data, and the feature amount calculated by the feature amount estimation module, and to output the entry selection probability as a selection probability calculation result; and an effect estimation module configured to execute selection processing of selecting a candidate entry to be included in the schedule based on the selection probability calculation result, generate search range information indicating a search range of the scheduling system based on a result of the selection processing, and to output the search range information as a verification result.

According to at least one embodiment of this invention, it is possible to verify the effect of the AI system under development. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating an exemplary configuration of a computer system according to a first embodiment of this invention;

FIG. 2 is a diagram for illustrating an exemplary hardware configuration of a computer in the first embodiment;

FIG. 3 is a table for showing an example of learning data in the first embodiment;

FIG. 4 is a flow chart for illustrating processing to be executed by the computer in the first embodiment;

FIG. 5 is a table for showing an example of feature amount data generated by a feature amount generation module in the first embodiment;

FIG. 6 is a diagram for illustrating exemplary structure of a model generated by a learning module in the first embodiment;

FIG. 7 is a flow chart for illustrating processing to be executed by the computer in the first embodiment;

FIG. 8 is a table for showing an example of target data to be input to the computer in the first embodiment;

FIG. 9 is a table for showing an example of processing results of a selection indicator calculation module stored in a storage module in the first embodiment;

FIG. 10 is a flow chart for illustrating an example of effect estimation processing to be executed by the computer in the first embodiment; and

FIG. 11A and FIG. 11B are diagrams for illustrating examples of a screen to be displayed based on effect estimation information output from the computer in the first embodiment.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### First Embodiment

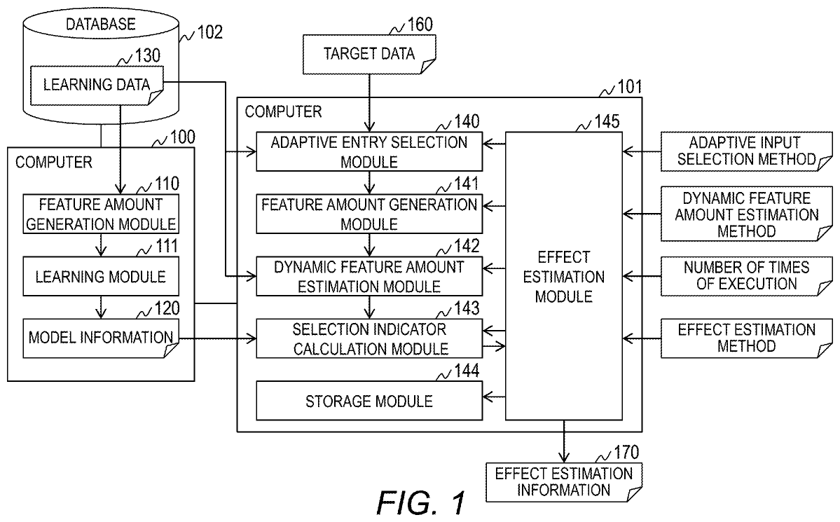

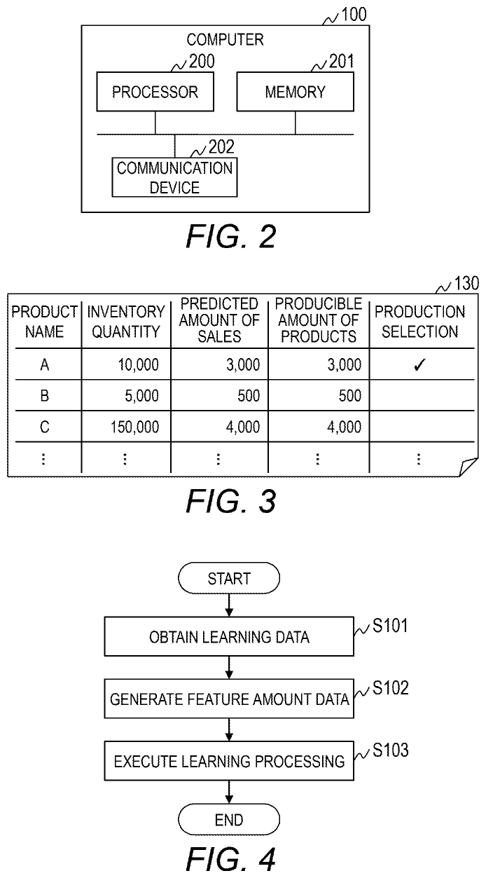

FIG. 1 is a diagram for illustrating an exemplary configuration of a computer system according to a first embodiment of this invention. FIG. 2 is a diagram for illustrating an exemplary hardware configuration of a computer in the first embodiment. FIG. 3 is a table for showing an example of learning data in the first embodiment.

The computer system includes a plurality of computers 100 and 101, and a database 102. The computer 100, the computer 101, and the database 102 may be coupled to one another directly or via a network. The network is, for example, a local area network (LAN) or a wide area network (WAN). The network coupling may be any one of wired coupling and wireless coupling.

The database 102 stores learning data 130. The database 102 may be a storage device such as a hard disk drive (HDD) and a solid state drive (SSD), or may be a storage system including at least one of the storage devices and a controller.

The learning data 130 includes at least one entry including input data and training data. The input data includes values of a plurality of items. The learning data 130 shown in FIG. 3 stores an entry of input data, which includes a product name, an inventory quantity, a predicted amount of sales, and a producible amount of products as items, and training data including production selection. The input data is data on a product for which a schedule is to be made. The production selection is information indicating that the product is actually selected.

The computer 100 is a computer configured to execute learning processing for generating a model to be used for an AI system. The computer 100 includes a processor 200, a memory 201, and a communication device 202. Those pieces of hardware are coupled to one another via a bus. The computer 100 may include a storage device, an input device such as a keyboard, a mouse, and a touch panel, and an output device, for example, a display.

The processor 200 is configured to execute a program stored in the memory 201. The processor 200 operates as a functional module (module) configured to implement a specific function by executing processing in accordance with a program. In the following description of processing, when a functional module is set as a subject of a sentence, this means that the processor 200 executes a program for implementing the functional module.

The memory 201 stores a program to be executed by the processor 200 and data to be used by the program. Further, the memory 201 includes a work area to be temporarily used by the program. The program and data stored in the memory 201 are described later.

The communication device 202 is a device for communicating to/from an external device. The communication device 202 is, for example, a network interface.

The memory 201 stores programs for implementing a feature amount generation module 110 and a learning module 111.

The feature amount generation module 110 is configured to calculate a feature amount based on a value of an item included in input data, and generate feature amount data including at least one feature amount.

The learning module 111 is configured to execute learning processing by using the feature amount data generated by the feature amount generation module 110. The learning module 111 is configured to output model information 120 defining a model as a result of the learning processing. The model is an algorithm for predicting any phenomenon.

The computer 101 is a computer configured to implement an AI system configured to handle a scheduling problem. The hardware configuration of the computer 101 is the same as that of the computer 100, and thus description thereof is omitted here. Target data 160 to be used for simulation of the AI system is input to the computer 101. The target data 160 includes at least one entry having values of a plurality of items. The entry is data on a target to be scheduled.

In the first embodiment, in particular, an exemplary description is made of an AI system (scheduling system) configured to generate a production plan (schedule) for a product. This AI system generates a production plan for a product, which maximizes a production efficiency or profit, for example. More specifically, in a case of receiving the target data 160 including a plurality of entries having values for a product, the AI system executes a processing flow a plurality of number of times. The processing flow is a series of processing steps of selecting an entry to be processed, calculating a feature amount of the entry, and calculating a probability of selecting a product (production step) based on the feature amount and the model. The AI system generates a plurality of production plans (schedules) by selecting a candidate entry based on the result of each processing flow and combining the candidate entries. Further, the AI system calculates a score of each production plan, and outputs an optimal production plan based on the score.

Further, simulation of the AI system means simulation of a processing flow. When the AI system is under development, logics such as a logic of selecting an entry to be processed and a logic of selecting an entry based on the selection probability are also under development. Further, a feature amount that is not determined based on external input, for example, a state value that changes in response to the previous selection result, is unclear. Thus, simulation of the AI system under development cannot be performed in the related art. In view of this, in the first embodiment, a function and information for implementing simulation of an AI system under development are added.

The memory 201 of the computer 101 stores programs for implementing an adaptive entry selection module 140, a feature amount generation module 141, a dynamic feature amount estimation module 142, a selection indicator calculation module 143, a storage module 144, and an effect estimation module 145.

The adaptive entry selection module 140 is a functional module configured to simulate a logic of selecting an entry to be processed, and is configured to select an entry matching a predetermined condition from among entries included in the target data 160. Specifically, the adaptive entry selection module 140 selects a predetermined number of entries based on a method of selecting an adaptive entry input via the effect estimation module 145.

The feature amount generation module 141 is configured to calculate a feature amount based on a value of an item included in the selected entry, and generate feature amount data including at least one feature amount.

The dynamic feature amount estimation module 142 is a functional module configured to estimate a feature amount that is not determined based on the external input. The dynamic feature amount estimation module 142 calculates a feature amount to be handled by a model, namely, a feature amount that is not included in the feature amount data generated by the feature amount generation module 141. The feature amount that is not generated by the feature amount generation module 141 means a feature amount that is not determined based on the external input. For example, when a factory for producing a product is assumed, the number of inventories of the product and the number of inventories of a raw material in the factory are not uniquely determined based on information (external input) on a product to be produced.

In the following description, the feature amount generated by the dynamic feature amount estimation module 142 is referred to as “dynamic feature amount”.

The selection indicator calculation module 143 is configured to calculate a value indicating a result of predicting any phenomenon by using the feature amount, the dynamic feature amount, and the model information 120. In the first embodiment, a probability (selection probability) serving as a selection indicator of an entry is calculated. The selection indicator calculation module 143 calculates the selection probability of each entry selected by the adaptive entry selection module 140.

The storage module 144 is configured to store the result of processing by the selection indicator calculation module 143.

The effect estimation module 145 is a functional module configured to simulate a logic of selecting an entry based on the selection probability, and is configured to select an entry based on the probability of selecting the entry. The effect estimation module 145 is also a functional module configured to verify the effect of the AI system, and is configured to estimate the effect of the AI system based on the selection result, and output the result of estimating the effect of the AI system as effect estimation information 170. Further, the effect estimation module 145 also functions as an interface configured to receive various kinds of settings information for implementing simulation of the AI system.

Specifically, the effect estimation module 145 receives information on an adaptive entry selection method, a dynamic feature amount estimation method, the number of times of execution, and an effect estimation method. The adaptive entry selection method is a method of selecting an entry. The dynamic feature amount estimation method is a method of calculating a dynamic feature amount. The number of times of execution is the number of times of execution of simulation. The effect estimation method is a method of estimating the effect of the AI system.

The information on the adaptive entry selection method includes information on a method of selecting an entry included in the target data 160 and a method of determining the number of entries to be selected. For example, a random selection method is conceivable as the method of selecting an entry included in the target data 160. A determination method based on the average number of pieces of learning data 130 is conceivable as the method of determining the number of entries to be selected.

The information on the dynamic feature amount estimation method includes information on an estimation method for each type of the dynamic feature amount. For example, regarding excess inventory days being one of feature amounts described later, an average value of excess inventory days of the same product of the learning data 130 is calculated as the dynamic feature amount, and regarding the producible amount of products being one of the feature amounts described later, an average value of producible amounts of the same product of the learning data 130 is calculated as the dynamic feature amount.

The information on the effect estimation method includes information on a threshold value of the selection probability being a reference for selecting an entry, an entry selection method based on the selection probability, and processing of handling a case in which an entry cannot be selected. The entry selection method based on the selection probability involves selecting top five entries in terms of selection probability from among entries having a selection probability larger than the threshold value, for example. The handling processing involves outputting alert information, for example.

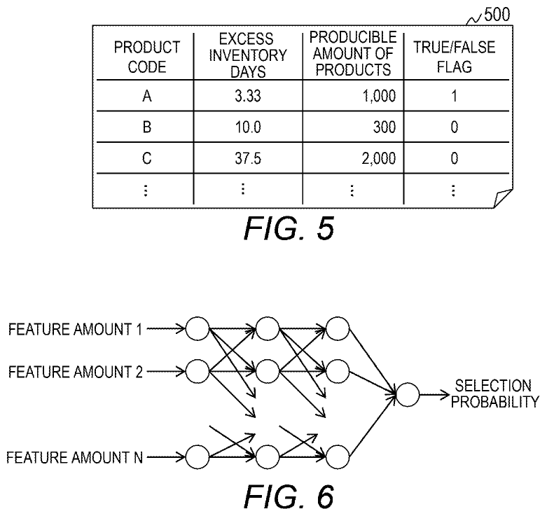

FIG. 4 is a flow chart for illustrating processing to be executed by the computer 100 in the first embodiment. FIG. 5 is a table for showing an example of feature amount data generated by the feature amount generation module 110 in the first embodiment. FIG. 6 is a diagram for illustrating exemplary structure of a model generated by the learning module 111 in the first embodiment.

The computer 100 executes processing described below in a case where the computer 100 has received an execution instruction, or periodically.

The computer 100 obtains the learning data 130 from the database 102 (Step S101). Any number of pieces of learning data 130 may be obtained.

Next, the computer 100 generates one piece of feature amount data from one entry included in one piece of learning data 130 (Step S102). Specifically, the following processing is executed.

(Step S102-1) The feature amount generation module 110 selects one piece of learning data 130.

(Step S102-2) The feature amount generation module 110 selects one entry from the selected piece of learning data 130.

(Step S102-3) The feature amount generation module 110 calculates a feature amount based on a value of an item of the selected entry. The feature amount generation module 110 generates feature amount data formed of a plurality of feature amounts.

(Step S102-4) The feature amount generation module 110 determines whether feature amount data on all the entries included in the selected piece of learning data 130 is generated. In a case where the feature amount data on all the entries included in the selected piece of learning data 130 is not generated, the feature amount generation module 110 returns to Step S102-2 to execute similar processing.

(Step S102-5) In a case where the feature amount data on all the entries included in the selected piece of learning data 130 is generated, the feature amount generation module 110 determines whether the processing is complete for all the pieces of learning data 130. In a case where the processing is not complete for all the pieces of learning data 130, the feature amount generation module 110 returns to Step S102-1 to execute similar processing. In a case where the processing is complete for all the pieces of learning data 130, the feature amount generation module 110 finishes the processing of Step S102.

Data 500 as shown in FIG. 5 is generated from one piece of learning data 130. One entry included in the data 500 corresponds to one piece of feature amount data. The feature amount data shown in FIG. 5 includes a product code, an excess inventory days, a producible amount of products, and a true/false flag. This concludes the description of the processing of Step S102.

Next, the computer 100 executes learning processing using the feature amount data (Step S103).

Specifically, the learning module 111 inputs, to a neural network as illustrated in FIG. 6, the feature amounts included in the feature amount data which corresponds to the input data, and calculates the probability of selecting each entry. Further, the learning module 111 selects an entry based on the selection probability. The learning module 111 updates the weight of the neural network based on an error between the selection result and the true/false flag of the feature amount data, and reflects the update result in the model information 120.

The model may not be a neural network. For example, the model may be a decision tree. Further, the learning method is not limited to the above-mentioned method.

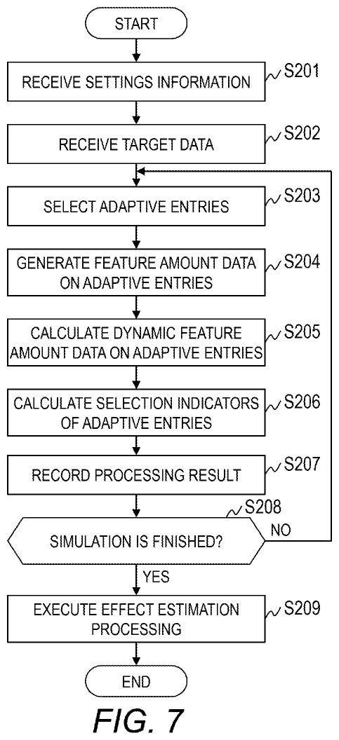

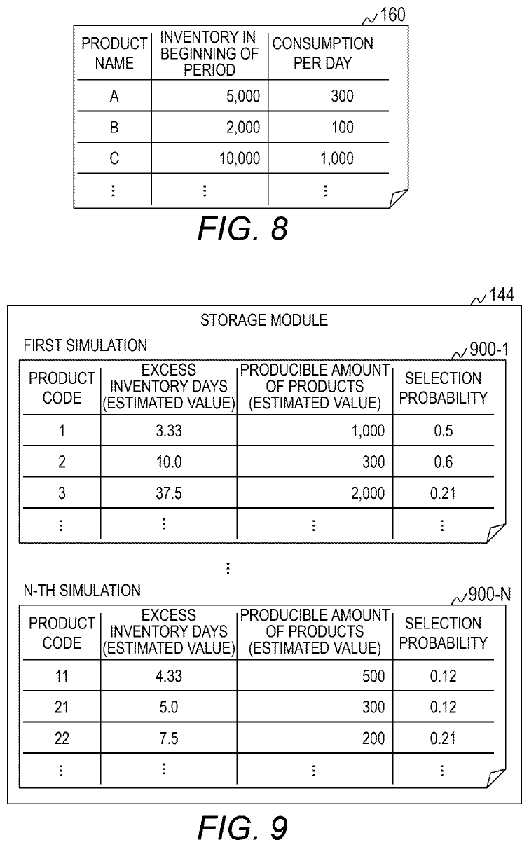

FIG. 7 is a flow chart for illustrating processing to be executed by the computer 101 in the first embodiment. FIG. 8 is a table for showing an example of the target data 160 to be input to the computer 101 in the first embodiment. FIG. 9 is a table for showing an example of processing results of the selection indicator calculation module 143 stored in the storage module 144 in the first embodiment.

The computer 101 executes processing described below in a case of receiving an execution instruction.

The computer 101 receives settings information (Step S201). Specifically, the following processing is executed.

(Step S201-1) The effect estimation module 145 receives information on the adaptive entry selection method, the dynamic feature amount estimation method, the number of times of execution, and the effect estimation method.

(Step S201-2) The effect estimation module 145 sets the information on the adaptive entry selection method in the adaptive entry selection module 140, and sets the information on the dynamic feature amount estimation method in the dynamic feature amount estimation module 142. Further, the effect estimation module 145 sets the number of times of execution and the effect estimation method in itself.

(Step S201-3) The effect estimation module 145 sets an execution counter to an initial value of 0.

This concludes the description of the processing of Step S201.

Next, the computer 101 receives the target data 160 (Step S202). For example, the computer 101 receives the target data 160 as shown in FIG. 8. At this time, after the effect estimation module 145 adds 1 to the execution counter, the effect estimation module 145 calls the adaptive entry selection module 140.

Next, the computer 101 selects adaptive entries from among entries included in the target data 160 (Step S203).

Specifically, the adaptive entry selection module 140 selects, as adaptive entries, a predetermined number of entries from among entries included in the target data 160 based on the adaptive entry selection method. The adaptive entry selection module 140 outputs the selected adaptive entries to the effect estimation module 145. The effect estimation module 145 activates the feature amount generation module 141.

The adaptive entry selection module 140 may access the database 102 to refer to the learning data 130 as required. For example, in a case where an adaptive entry is selected or the number of adaptive entries to be selected is determined based on information on the learning data 130, the adaptive entry selection module 140 accesses the database 102.

Next, the computer 101 generates feature amount data on the adaptive entries (Step S204). Specifically, the following processing is executed.

(Step S204-1) The feature amount generation module 141 selects one adaptive entry.

(Step S204-2) The feature amount generation module 141 calculates a feature amount based on a value of an item of the selected adaptive entry. The feature amount generation module 141 generates feature amount data formed of a plurality of feature amounts.

(Step S204-3) The feature amount generation module 141 determines whether the processing is complete for all the adaptive entries. In a case where the processing is not complete for all the adaptive entries, the feature amount generation module 141 returns to Step S204-1 to execute similar processing. In a case where the processing is complete for all the adaptive entries, the feature amount generation module 141 outputs a plurality of pieces of feature amount data associated with the adaptive entries to the effect estimation module 145, and finishes the processing of Step S204. The effect estimation module 145 calls the dynamic feature amount estimation module 142.

This concludes the description of the processing of Step S204.

Next, the computer 101 generates dynamic feature amount data on the adaptive entries (Step S205). Specifically, the following processing is executed.

(Step S205-1) The dynamic feature amount estimation module 142 selects one adaptive entry.

(Step S205-2) The dynamic feature amount estimation module 142 calculates a dynamic feature amount based on the dynamic feature amount estimation method, and generates dynamic feature amount data formed of a plurality of dynamic feature amounts.

The dynamic feature amount estimation module 142 may access the database 102 to refer to the learning data 130 as required. For example, in a case where a dynamic feature amount is calculated based on the learning data 130, the dynamic feature amount estimation module 142 accesses the database 102.

(Step S205-3) The dynamic feature amount estimation module 142 determines whether the processing is complete for all the adaptive entries. In a case where the processing is not complete for all the adaptive entries, the dynamic feature amount estimation module 142 returns to Step S205-1 to execute similar processing. In a case where the processing is complete for all the adaptive entries, the dynamic feature amount estimation module 142 outputs dynamic feature amount data associated with the adaptive entries to the effect estimation module 145, and finishes the processing of Step S205. The effect estimation module 145 calls the selection indicator calculation module 143, and inputs the feature amount data and dynamic feature amount data on the adaptive entries.

Next, the computer 101 uses the model information 120, the feature amount data, and the dynamic feature amount data to calculate selection indicators of the adaptive entries (Step S206). Specifically, the following processing is executed.

(Step S206-1) The selection indicator calculation module 143 selects one adaptive entry.

(Step S206-2) The selection indicator calculation module 143 inputs feature amount data and dynamic feature amount data on the selected entry to a model defined in the model information 120. In this manner, the probability of selecting the adaptive entry is calculated.

(Step S206-3) The selection indicator calculation module 143 determines whether the processing is complete for all the adaptive entries. In a case where the processing is not complete for all the adaptive entries, the selection indicator calculation module 143 returns to Step S206-1 to execute similar processing. In a case where the processing is complete for all the adaptive entries, the selection indicator calculation module 143 outputs the selection probabilities associated with the adaptive entries to the effect estimation module 145, and finishes the processing of Step S206.

This concludes the description of the processing of Step S206.

Next, the computer 101 records the processing results of the selection indicator calculation module 143 (Step S207).

Specifically, the effect estimation module 145 stores a simulation result 900 including the selection probability associated with each adaptive entry into the storage module 144. For example, the simulation result 900 as shown in FIG. 9 is stored into the storage module 144. The simulation result 900 includes the dynamic feature amount and selection probability for each adaptive entry.

The processing of from Step S203 to Step S207 is one simulation of the AI system. One simulation result 900 is generated through one simulation. FIG. 9 is an illustration of a state of the storage module 144 after N simulations are executed.

Next, the computer 101 determines whether to finish the simulation (Step S208).

Specifically, the effect estimation module 145 determines whether the value of the execution counter is equal to or larger than a threshold value of the number of times of execution. In a case where the value of the execution counter is equal to or larger than the threshold value of the number of times of execution, the effect estimation module 145 determines to finish the simulation.

In a case where the simulation is not finished, the computer 101 returns to Step S203 to execute similar processing. At this time, the effect estimation module 145 adds 1 to the execution counter.

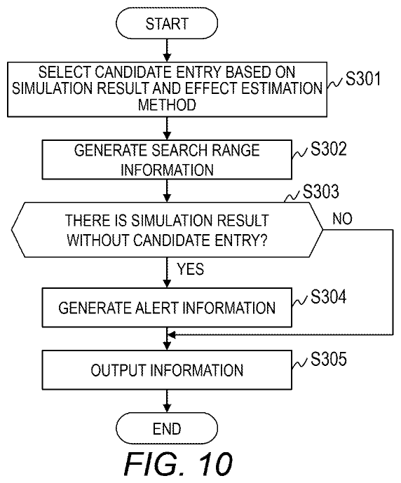

In a case where the simulation is finished, the computer 101 executes effect estimation processing (Step S209). After that, the computer 101 finishes the processing. Details of the effect estimation processing are described with reference to FIG. 10.

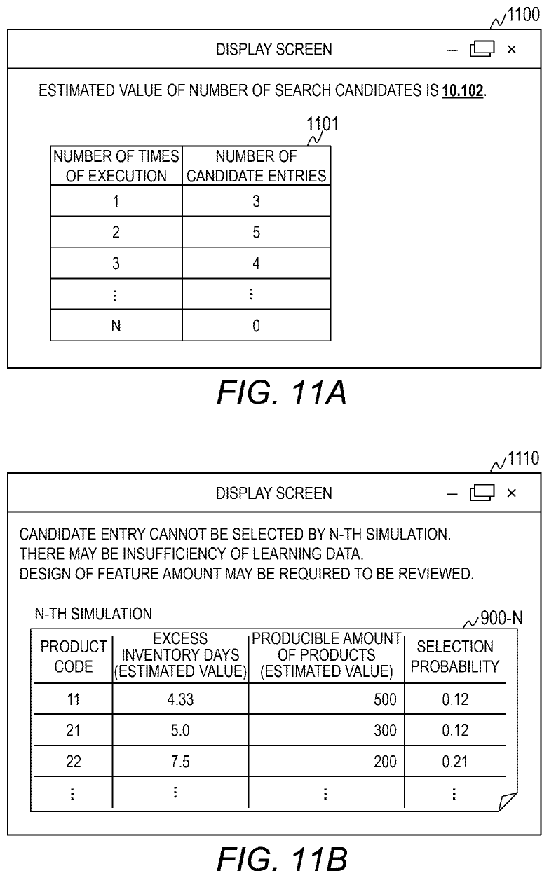

FIG. 10 is a flow chart for illustrating an example of the effect estimation processing to be executed by the computer 101 in the first embodiment. FIG. 11A and FIG. 11B are diagrams for illustrating examples of a screen to be displayed based on the effect estimation information 170 output from the computer 101 in the first embodiment.

The effect estimation module 145 selects a candidate entry of each simulation result 900 based on the effect estimation method and the processing result (simulation result 900) stored in the storage module 144 (Step S301).

For example, the effect estimation module 145 refers to the simulation result 900 to select, as candidate entries, top five adaptive entries in terms of selection probability from among adaptive entries having a selection probability equal to or larger than 0.5.

Next, the effect estimation module 145 generates search range information based on the result of selecting candidate entries of each simulation result 900 (Step S302).

For example, the effect estimation module 145 calculates a value obtained by multiplying numbers of candidate entries of respective simulation results 900. The effect estimation module 145 generates the search range information including the calculated value and information on the numbers of candidate entries of respective simulation results 900. In the above-mentioned calculation processing, the simulation result 900 for which the number of candidate entries is 0 is excluded.

The search range in the problem of a production plan is represented as the number of combinations of entries. The AI system reduces the number of combinations of entries to be evaluated by narrowing down entries by one simulation. The AI system generates a predetermined number of production plans by combining entries selected by each simulation. Further, the AI system scores each production plan to output an optimal production plan. In a case where there are a large number of entries selected by simulation, the number of combinations of entries, namely, the number of production plans becomes larger. This means the fact that the search range is wide.

The search range is information useful for estimating, for example, the amount of resources, calculation performance, and calculation period required for the AI system. In view of this, the effect estimation module 145 outputs a value relating to the number of combinations of candidate entries as information for evaluating the search range.

Next, the effect estimation module 145 determines whether there is a simulation result 900 without any candidate entry (Step S303). In other words, it is determined whether an alert is required to be issued.

In a case where there is no simulation result 900 without any candidate entry, the effect estimation module 145 advances to Step S305.

In a case where there is a simulation result 900 without any candidate entry, the effect estimation module 145 generates alert information (Step S304), and then advances to Step S305.

In a case where there is no candidate entry, it is considered that the learning data is insufficient and the design of a feature amount has some fault. In view of this, in a case where there is a simulation result 900 without any candidate entry, the effect estimation module 145 generates the alert information notifying of at least one of the insufficiency of learning data or the fault of design of a feature amount.

In Step S305, the effect estimation module 145 outputs the effect estimation information 170 (Step S305). After that, the effect estimation module 145 finishes the effect estimation processing. The effect estimation information 170 includes the search range information. Further, in a case where the determination of Step S303 results in “YES”, the effect estimation information 170 includes the alert information.

Screens as illustrated in FIG. 11A and FIG. 11B are displayed based on the effect estimation information 170.

FIG. 11A is an illustration of a screen 1100 to be displayed based on the search range information included in the effect estimation information 170. The screen 1100 displays the calculated value and a table 1101 being information on the number of candidate entries of each simulation result 900. Though presentation of the screen 1100, a developer or a user can verify the search range, namely, the effect of the AI system.

FIG. 11B is an illustration of a screen 1110 to be displayed based on the alert information included in the effect estimation information 170. For example, a method of switching the screen when the value “0” in the number of candidate entries of the table 1101 is operated is conceivable. The simulation result 900 and the details of the alert are displayed on the screen 1110. Though presentation of the screen 1110, it is possible to prompt the developer or user to add the learning data and review the design of the feature amount.

The effect of the AI system may be verified based on one simulation result.

In a case where the computer 101 holds information for calculating an amount of resources, calculation performance, or a calculation period based on the search range information, the computer 101 may present the amount of resources, the calculation performance, or the calculation period.

As described above, according to of at least one embodiment this invention, it is possible to implement simulation of an AI system under development and verify the effect of the AI system.

This invention is not limited to the above-mentioned at least one embodiment, and includes various modification examples. Further, for example, the configuration of the above-mentioned at least one embodiment is described in detail to clearly describe this invention, and this invention is not always limited to the one including all the configurations described above. Further, a part of the configuration of each embodiment may be added to, deleted from, or replaced with other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, which is configured to verify a scheduling system generating a schedule,
the scheduling system being configured to generate, in a case of receiving input of target data including a plurality of entries each being data on a target to be scheduled and including a plurality of data items, the schedule formed of the plurality of entries, which are ordered by using a model for calculating an entry selection probability based on a feature amount calculated based on values of the plurality of data items included in the one of the plurality of entries,
the computer system comprising:
at least one computer including an arithmetic device, a storage device coupled to the arithmetic device, and an interface coupled to the arithmetic device;
a first storage module configured to manage information on the model;
a selection module configured to select at least one of the plurality of entries from the target data for verification;
a feature amount calculation module configured to calculate a feature amount based on the values of the plurality of data items included in the at least one of the plurality of entries selected by the selection module, and to generate feature amount data formed of the calculated feature amount;
a feature amount estimation module configured to estimate a feature amount to be handled by the model, which is a feature amount not included in the feature amount data;
a selection probability calculation module configured to calculate an entry selection probability by using the information on the model, the feature amount data, and the feature amount calculated by the feature amount estimation module, and to output the entry selection probability as a selection probability calculation result; and
an effect estimation module configured to execute selection processing of selecting a candidate entry to be included in the schedule based on the selection probability calculation result, generate search range information indicating a search range of the scheduling system based on a result of the selection processing, and to output the search range information as a verification result.

2. The computer system according to claim 1, wherein the effect estimation module is configured to:
generate a plurality of the selection probability calculation results by executing simulation a plurality of number of times, the simulation including processing in which the selection module, the feature amount calculation module, the feature amount estimation module, and the selection probability calculation module cooperate with each other;
execute the selection processing for each of the plurality of selection probability calculation results; and
output the search range information including a value calculated by using a number of candidate entries selected in each of a plurality of number of times of the selection processing.

3. The computer system according to claim 1, wherein the effect estimation module is configured to:
generate a plurality of the selection probability calculation results by executing simulation a plurality of number of times, the simulation including processing in which the selection module, the feature amount calculation module, the feature amount estimation module, and the selection probability calculation module cooperate with each other;
execute the selection processing for each of the plurality of selection probability calculation results;
analyze a result of each of a plurality of number of times of the selection processing;
determine, based on a result of the analysis, whether an alert is required to be output, the alert notifying of at least one of insufficiency of learning data for generating the model or review of design of the feature amount; and
output, in a case where the alert is required to be output, alert information including the result of the selection processing, which is a basis for the determination.

4. The computer system according to claim 1, further comprising a second storage module configured to store learning data used for generating the model,
wherein the selection module is configured to:
analyze the learning data stored in the second storage module; and
determine, based on a result of the analysis, a number of entries to be selected from the target data for verification.

5. The computer system according to claim 1, further comprising a second storage module configured to store learning data used for generating the model,
wherein the feature amount estimation module is configured to:
analyze the learning data stored in the second storage module; and
estimate the feature amount not included in the feature amount data based on a result of the analysis.

6. The computer system according to claim 1, wherein the computer system is configured to receive input of information on a method of selecting at least one of the plurality of entries by the selection module, a method of calculating the feature amount not included in the feature amount data by the feature amount estimation module, a number of times of execution of the selection processing, and a method of selecting the candidate entry based on the entry selection probability.

7. A method of verifying a scheduling system generating a schedule, which is executed by a computer system,
the scheduling system being configured to generate, in a case of receiving input of target data including a plurality of entries each being data on a target to be scheduled and including a plurality of data items, the schedule formed of the plurality of entries, which are ordered by using a model for calculating an entry selection probability based on a feature amount calculated based on values of the plurality of data items included in the one of the plurality of entries,
the computer system including at least one computer including: an arithmetic device; a storage device coupled to the arithmetic device; and an interface coupled to the arithmetic device,
the computer system being configured to manage information on the model,
the method of verifying a scheduling system including:
a first step of selecting, by the arithmetic device, at least one of the plurality of entries form the target data for verification;
a second step of calculating, by the arithmetic device, a feature amount based on the values of the plurality of data items included in the selected at least one of the plurality of entries, and generating feature amount data formed of the calculated feature amount;
a third step of estimating, by the arithmetic device, a feature amount to be handled by the model, which is a feature amount not included in the feature amount data;
a fourth step of calculating, by the arithmetic device, an entry selection probability by using the information on the model, the feature amount data, and the feature amount calculated in the third step, and outputting the entry selection probability as a selection probability calculation result; and
a fifth step of executing, by the arithmetic device, selection processing of selecting a candidate entry to be included in the schedule based on the selection probability calculation result, generating search range information indicating a search range of the scheduling system based on a result of the selection processing, and outputting the search range information as a verification result.

8. The method of verifying a scheduling system according to claim 7, wherein the fifth step includes:
generating, by the arithmetic device, a plurality of the selection probability calculation results by executing simulation a plurality of number of times, the simulation including the first step, the second step, the third step, and the fourth step;
executing, by the arithmetic device, the selection processing for each of the plurality of selection probability calculation results; and
outputting, by the arithmetic device, the search range information including a value calculated by using a number of candidate entries selected in each of a plurality of number of times of the selection processing.

9. The method of verifying a scheduling system according to claim 7, wherein the fifth step includes:
generating, by the arithmetic device, a plurality of the selection probability calculation results by executing simulation a plurality of number of times, the simulation including the first step, the second step, the third step, and the fourth step;
executing, by the arithmetic device, the selection processing for each of the plurality of selection probability calculation results;
analyzing, by the arithmetic device, a result of each of a plurality of number of times of the selection processing;
determining, by the arithmetic device, based on a result of the analysis, whether an alert is required to be output, the alert notifying of at least one of insufficiency of learning data for generating the model or review of design of the feature amount; and
outputting, by the arithmetic device, in a case where the alert is required to be output, alert information including the result of the selection processing, which is a basis for the determination.

10. The method of verifying a scheduling system according to claim 7,
wherein the computer system is configured to manage learning data used for generating the model, and
wherein the first step includes:
analyzing, by the arithmetic device, the learning data; and
determining, by the arithmetic device, based on a result of the analysis, a number of entries to be selected from the target data for verification.

11. The method of verifying a scheduling system according to claim 7,
wherein the computer system is configured to manage learning data used for generating the model, and
wherein the third step includes:
analyzing, by the arithmetic device, the learning data; and
estimating, by the arithmetic device, the feature amount not included in the feature amount data based on a result of the analysis.

12. The method of verifying a scheduling system according to claim 7, further including receiving, by the arithmetic device, input of information on a method of selecting at least one of the plurality of entries in the first step, a method of calculating the feature amount not included in the feature amount data in the third step, a number of times of execution of the selection processing, and a method of selecting the candidate entry based on the entry selection probability.
